(19) United States
(12) Patent Application Publication
(10) Pub. No.: US 2007/0240914 A1
(43) Pub. Date: Oct. 18, 2007

(54) Transparent touch panel

(75) Inventors: Yuang Wei Lai, Changhua (TW); Yih Chang, Jhonghe (TW); Tung Yang Tang, Jhubei (TW); Chun Chieh Kuo, Kaohsiung (TW)

Correspondence Address: OLIFF & BERRIDGE, PLC, P.O. BOX 19928, ALEXANDRIA, VA, 22320, US

(73) Assignee: RITDISPLAY CORPORATION, HSIN CHU (TW)

(21) Appl. No.: 11/783,848

(22) Filed: Apr. 12, 2007

(30) Foreign Application Priority Data
Apr. 14, 2006 (TW) 095113492

(51) Int. Cl. G08C 21/00

(52) U.S. Cl. 178/18.06

(57) ABSTRACT

A transparent touch panel according to this aspect of the present invention comprises a transparent substrate, a capacitive touch device positioned on the transparent substrate, an interfacial structure positioned on the capacitive touch device, and a display device positioned on the interfacial structure. The capacitive touch device includes a plurality of first sensing blocks positioned on the transparent substrate, a dielectric layer covering the first sensing blocks, a plurality of second sensing blocks positioned on the dielectric layer, a plurality of first wires positioned on the transparent substrate, and a plurality of second wires positioned on the dielectric layer. Preferably, the first sensing blocks and the second sensing blocks are interlaced, each first wire connects the first sensing blocks on the same column, and each second wire connects the second sensing blocks on the same row.

### BACKGROUND OF THE INVENTION

(A) Field of the Invention

The present invention relates to a transparent touch panel, and more particularly, to a transparent touch panel incorporating a capacitive touch device and a display device.

(B) Description of the Related Art

With the increasing demand for multimedia message technologies, the touch screen is widely utilized to replace the keyboard and mouse as the information-inputting device. This change is due to the fact that the touch screen is simple, small, and complies well with human nature. The touch screen has been widely applied to the tourist-guiding system, automatic teller machine, palm computer, vending machine, and industry control systems.

US 2002/0186208 A1 discloses an electro luminescent apparatus including a transparent substrate, a resistive touch device positioned on one surface of the transparent substrate, and an electro luminescent display on another surface of the transparent substrate. However, there is a likelihood of scrap generation during the fabrication process for the electro luminescent display and the resistive touch device on the two surfaces of the transparent substrate. In addition, the resistive touch device has a poor sensitivity.

US 2004/0080267 A1 discloses an integrated apparatus incorporating an organic light-emitting display and a resistive touch screen. The resistive touch screen is formed on a cap of the organic light-emitting display in advance, and the cap is then used to encapsulate the organic light-emitting display. However, the resistive touch screen possesses a poor sensitivity and requires the user to use a tip of pens touch to indicate the touch site, and using the resistive touch screen is likely to generate scrap. In addition, it is likely to damage the resistive touch screen when the cap is used to encapsulate the organic light-emitting display.

US 2004/0080267 A1 discloses an integrated apparatus incorporating an organic light-emitting display and a resistive touch screen, in which the resistive touch screen is formed on a transparent substrate (or cap) of the organic light-emitting display after encapsulation. However, the fabrication processes disclosed by US 2004/0080267 A1 is very complicated, and the lifetime of the organic light-emitting display is shortened due to the fabrication of the resistive touch screen on the transparent cap of the organic light-emitting display. In addition, the resistive touch device has a poor sensitivity.

### SUMMARY OF THE INVENTION

One aspect of the present invention provides a phase shifting mask capable of reducing the optical proximity effect.

A transparent touch panel according to this aspect of the present invention comprises a transparent substrate, a capacitive touch device positioned on the transparent substrate, an interfacial structure positioned on the capacitive touch device, and a display device positioned on the interfacial structure. The interfacial structure includes an insulating polymer layer positioned on the capacitive touch device and a silicon oxide layer positioned on the insulating polymer layer. Preferably, the interfacial structure further includes a conductive layer positioned between the insulating polymer layer and the silicon oxide layer.

Another aspect of the present invention provides a transparent touch panel comprising a transparent substrate having a top surface and a bottom surface, a display device positioned on the top surface, an interfacial structure positioned on the bottom surface, a capacitive touch device positioned on the interfacial structure, and a protective polymer layer covering the capacitive touch device.

The capacitive touch device according to the first embodiment of the present invention includes a first conductive pattern positioned on the transparent substrate, a plurality of first wires positioned on the transparent substrate, a dielectric layer covering the first conductive pattern and the first wires, a second conductive pattern positioned on the dielectric layer, and a plurality of second wires positioned on the dielectric layer. The first conductive pattern includes a plurality of first sensing blocks positioned in an array manner, and the second conductive pattern includes a plurality of second sensing blocks positioned in an array manner. Preferably, the first sensing blocks and the second sensing blocks are interlaced, each first wire connects the first sensing blocks on the same column, and each second wire connects the second sensing blocks on the same row.

The capacitive touch device according to the second embodiment of the present invention includes a first conductive pattern positioned on the transparent substrate, a plurality of first wires positioned on the transparent substrate, a second conductive pattern positioned on the transparent substrate, a dielectric layer covering the first conductive pattern, the first wires, and the second conductive pattern, and a plurality of second wires positioned on the dielectric layer. The first conductive pattern includes a plurality of first sensing blocks positioned in an array manner, and the second conductive pattern includes a plurality of second sensing blocks positioned in an array manner. Each first wire connects the first sensing blocks on the same column, and each second wire connects the second sensing blocks on the same row via a plurality of conductive plugs penetrating the dielectric layer.

### BRIEF DESCRIPTION OF THE DRAWINGS

The objectives and advantages of the present invention will become apparent upon reading the following description and upon reference to the accompanying drawings in which:

FIG. 1 to FIG. 4 illustrate a capacitive touch panel according to the first embodiment of the present invention;

FIG. 5 illustrates a capacitive touch device according to the second embodiment of the present invention; and

FIG. 6 and FIG. 7 illustrate a transparent touch panel according to the second embodiment of the present invention.

### DETAILED DESCRIPTION OF THE INVENTION

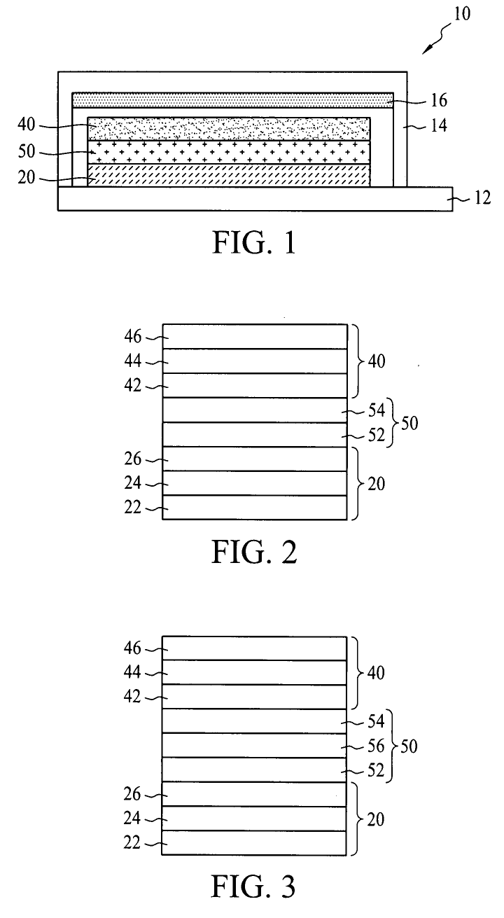

FIG. 1 to FIG. 4 illustrate a capacitive touch panel 10 according to the first embodiment of the present invention. The capacitive touch panel 10 comprises a transparent substrate 12, a capacitive touch device 20 positioned on the transparent substrate 12, an interfacial structure 50 positioned on the capacitive touch device 20, a display device 40 positioned on the interfacial structure 50, a cap 14 adhered to the transparent substrate 12 by glue (not shown in the drawing), and an absorbent 16. The transparent substrate 12 may include transparent material such as glass, polycarbonate, polyvinyl chloride and methyl methacrylate, and the display device 40 can be an electro luminescent display device, an organic light-emitting display device, or a liquid crystal display device.

Referring to FIG. 2, the display device 40 includes an anode layer 42, a light-emitting layer 44 and a cathode layer 46. The interfacial structure 50 includes an insulating polymer layer 52 positioned on the capacitive touch device 20 and a silicon oxide layer 54 positioned on the insulating polymer layer 52. The insulating polymer layer 52 may include transparent material such as epoxy resin, polyimide, polyvinyl chloride and methyl methacrylate. Preferably, the interfacial structure 50 may further include a conductive layer 56 positioned between the insulating polymer layer 52 and the silicon oxide layer 54 for electromagnetic interference shielding, as shown in FIG. 3. The conductive layer 56 may include transparent conductive material such as indium tin oxide, indium zinc oxide, and aluminum zinc oxide.

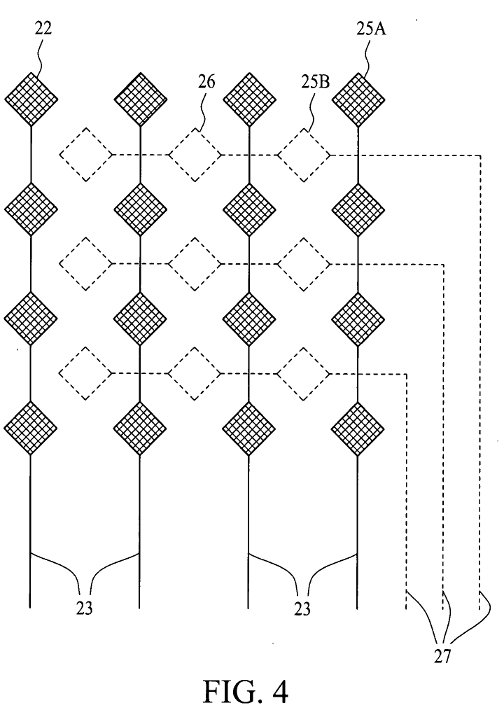

Referring to FIG. 3 and FIG. 4, the capacitive touch device 20 according to the first embodiment of the present invention includes a first conductive pattern 22 positioned on the transparent substrate 12, a plurality of first wires 23 positioned on the transparent substrate 12, a dielectric layer 24 covering the first conductive pattern 22 and the first wires 23, a second conductive pattern 26 positioned on the dielectric layer 24, and a plurality of second wires 27 positioned on the dielectric layer 24. The first conductive pattern 22 includes a plurality of first sensing blocks 25A positioned in an array manner, and the second conductive pattern 26 includes a plurality of second sensing blocks 25B positioned in an array manner.

Preferably, the first sensing blocks 25A and the second sensing blocks 25B are interlaced, each first wire 23 connects the first sensing blocks 25A on the same column, and each second wire 27 connects the second sensing blocks 25B on the same row. The first sensing blocks 25A and the second sensing blocks 25B may include transparent conductive material such as indium tin oxide, indium zinc oxide, and aluminum zinc oxide, and the dielectric layer 24 may include epoxy resin, polyimide, or methyl methacrylate.

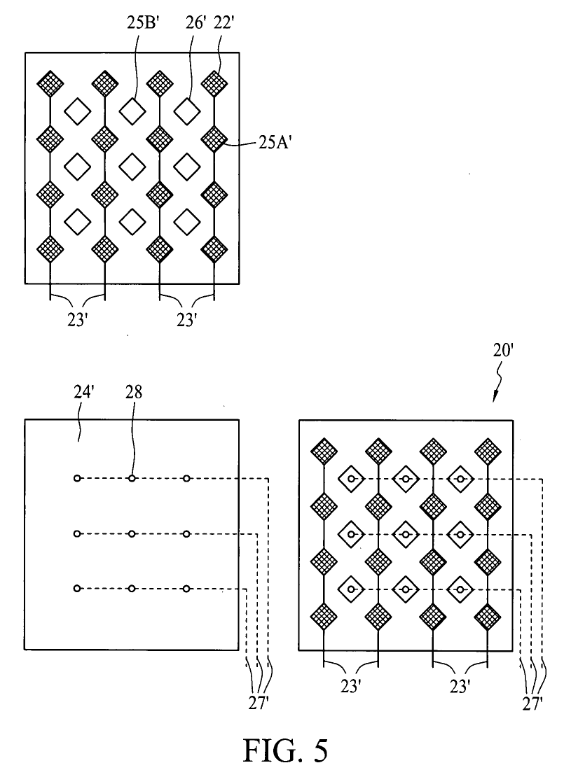

FIG. 5 illustrates a capacitive touch device 20′ according to the second embodiment of the present invention. The capacitive touch device 20′ includes a first conductive pattern 22′ positioned on the transparent substrate 12, a plurality of first wires 23′ positioned on the transparent substrate 12, a second conductive pattern 26′ positioned on the transparent substrate 12, a dielectric layer 24′ covering the first conductive pattern 22′, the first wires 23′ and the second conductive pattern 26′, and a plurality of second wires 27′ positioned on the dielectric layer 24′. The first conductive pattern 22′ includes a plurality of first sensing blocks 25A′ positioned in an array manner, and the second conductive pattern 26′ includes a plurality of second sensing blocks 25B′ positioned in an array manner. Each first wire 23′ connects the first sensing blocks 25A′ on the same column, and each second wire 27′ connects the second sensing blocks 25B′ on the same row via a plurality of conductive plugs 28 penetrating the dielectric layer 24′.

In particular, the capacitive touch device can be positioned on the transparent substrate 12 in an upside down manner, i.e., the second wires 27′ are positioned on the transparent substrate 12, the dielectric layer 24′ covering the second wires 27′, and the first conductive pattern 22′, the second conductive pattern 26′ and the first wires 23′ are positioned on the dielectric layer 24′.

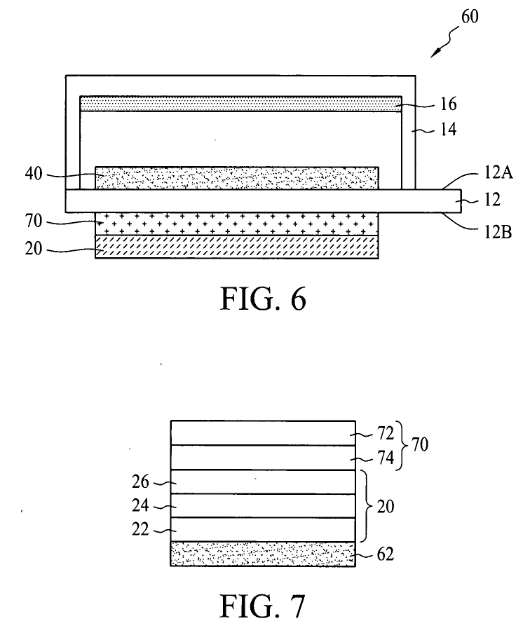

FIG. 6 and FIG. 7 illustrate a transparent touch panel 60 according to the second embodiment of the present invention. The transparent touch panel 60 comprises a transparent substrate 12 having a top surface 12A and a bottom surface 12B, a display device 40 positioned on the top surface 12A, an interfacial structure 70 positioned on the bottom surface 12B, a capacitive touch device 20 positioned on the interfacial structure 70, and a protective polymer layer 62 covering the capacitive touch device 20.

The interfacial structure 70 includes a conductive layer 72 positioned on the bottom surface 12B and an insulating polymer layer 74 positioned on the conductive layer 72. The protective polymer layer 62 and the insulating polymer layer 74 may include transparent material such as epoxy resin, polyimide, and methyl methacrylate, and the conductive layer 72 may include transparent conductive material such as indium tin oxide, indium zinc oxide, and aluminum zinc oxide for electromagnetic interference shielding.

The capacitive touch device 20 and the display device of the transparent touch panel 10 are encapsulated by the transparent substrate 12 and the transparent cap 14, and the capacitive touch device 20 and the display device of the transparent touch panel 60 are encapsulated by the transparent cap 14 and the protective polymer layer 60. Consequently, the transparent touch panels 10 and 60 possess high transparency, high corrosion resistance, and high scratch resistance such that the lifetime is increased and the application is extended to more hardwares. In addition, the touch-controlling circuit of the capacitive touch devices 20 and 20′ is capacitive, which possesses high precision, high reliability and can be used in high-temperature and high-humidity environments. Furthermore, the capacitive touch device 20 and the display device 40 can be fabricated on the same transparent substrate 12 to simplify the fabrication process.

The above-described embodiments of the present invention are intended to be illustrative only. Numerous alternative embodiments may be devised by those skilled in the art without departing from the scope of the following claims.

What is claimed is:

1. A transparent touch panel, comprising:
a transparent substrate:
a capacitive touch device positioned on the transparent substrate;
an interfacial structure positioned on the capacitive touch device; and
a display device positioned on the interfacial structure.

2. The transparent touch panel of claim 1, wherein the capacitive touch device includes:
a first conductive pattern positioned on the transparent substrate;
a dielectric layer covering the first conductive pattern; and
a second conductive pattern positioned on the dielectric layer.

3. The transparent touch panel of claim 2, wherein the first conductive pattern includes a plurality of first sensing blocks positioned in an array manner, and the second conductive pattern includes a plurality of second sensing blocks positioned in an array manner.

4. The transparent touch panel of claim 3, wherein the first sensing blocks and the second sensing blocks are interlaced.

5. The transparent touch panel of claim 3, wherein the capacitive touch device further includes:
a plurality of first wires positioned on the transparent substrate, each first wire connecting the first sensing blocks on the same column; and
a plurality of second wires positioned on the dielectric layer, each second wire connecting the second sensing blocks on the same row.

6. The transparent touch panel of claim 3, wherein the first sensing blocks or the second sensing blocks include indium tin oxide, indium zinc oxide, or aluminum zinc oxide.

7. The transparent touch panel of claim 1, wherein the capacitive touch device includes:
a first conductive pattern positioned on the transparent substrate;
a second conductive pattern positioned on the transparent substrate; and
a dielectric layer covering the first conductive pattern and the second conductive pattern.

8. The transparent touch panel of claim 7, wherein the first conductive pattern includes a plurality of first sensing blocks positioned in an array manner, and the second conductive pattern includes a plurality of second sensing blocks positioned in an array manner.

9. The transparent touch panel of claim 8, wherein the first sensing blocks and the second sensing blocks are interlaced.

10. The transparent touch panel of claim 8, wherein the capacitive touch device further includes:
a plurality of first wires positioned on the transparent substrate, each first wire connecting the first sensing blocks on the same column; and
a plurality of second wires positioned on the dielectric layer, each second wire connecting the second sensing blocks on the same row via a plurality of conductive plugs penetrating the dielectric layer.

11. The transparent touch panel of claim 8, wherein the first sensing blocks or the second sensing blocks include indium tin oxide, indium zinc oxide, or aluminum zinc oxide.

12. The transparent touch panel of claim 1, wherein the interfacial structure includes:
an insulating polymer layer positioned on the capacitive touch device; and
a silicon oxide layer positioned on the insulating polymer layer.

13. The transparent touch panel of claim 12, wherein the insulating polymer layer includes epoxy resin, polyimide, polyvinyl chloride, or methyl methacrylate.

14. The transparent touch panel of claim 12, wherein the interfacial structure further includes a conductive layer positioned between the insulating polymer layer and the silicon oxide layer.

15. The transparent touch panel of claim 14, wherein the conductive layer includes indium tin oxide, indium zinc oxide, or aluminum zinc oxide.

16. The transparent touch panel of claim 1, wherein the transparent substrate includes glass, polycarbonate, or methyl methacrylate.

17. The transparent touch panel of claim 1, wherein the display device is electro luminescent display device, organic light-emitting display device, or liquid crystal display device.

18. A transparent touch panel, comprising:
a transparent substrate having a top surface and a bottom surface;
a display device positioned on the top surface;
an interfacial structure positioned on the bottom surface; and
a capacitive touch device positioned on the interfacial structure.

19. The transparent touch panel of claim 18, wherein the capacitive touch device includes:
a first conductive pattern positioned on the transparent substrate;
a dielectric layer covering the first conductive pattern; and
a second conductive pattern positioned on the dielectric layer.

20. The transparent touch panel of claim 19, wherein the first conductive pattern includes a plurality of first sensing blocks positioned in an array manner, and the second conductive pattern includes a plurality of second sensing blocks positioned in an array manner.

21. The transparent touch panel of claim 20, wherein the first sensing blocks and the second sensing blocks are interlaced.

22. The transparent touch panel of claim 20, wherein the capacitive touch device further includes:
a plurality of first wires positioned on the transparent substrate, each first wire connecting the first sensing blocks on the same column; and
a plurality of second wires positioned on the dielectric layer, each second wire connecting the second sensing blocks on the same row.

23. The transparent touch panel of claim 20, wherein the first sensing blocks or the second sensing blocks include indium tin oxide, indium zinc oxide, or aluminum zinc oxide.

24. The transparent touch panel of claim 18, wherein the capacitive touch device includes:
a first conductive pattern positioned on the transparent substrate;
a second conductive pattern positioned on the transparent substrate; and
a dielectric layer covering the first conductive pattern and the second conductive pattern.

25. The transparent touch panel of claim 24, wherein the first conductive pattern includes a plurality of first sensing blocks positioned in an array manner, and the second conductive pattern includes a plurality of second sensing blocks positioned in an array manner.

26. The transparent touch panel of claim 25, wherein the first sensing blocks and the second sensing blocks are interlaced.

27. The transparent touch panel of claim 25, wherein the capacitive touch device further includes:
a plurality of first wires positioned on the transparent substrate, each first wire connecting the first sensing blocks on the same column; and
a plurality of second wires positioned on the dielectric layer, each second wire connecting the second sensing blocks on the same row via a plurality of conductive plugs penetrating the dielectric layer.

28. The transparent touch panel of claim 25, wherein the first sensing blocks or the second sensing blocks include indium tin oxide, indium zinc oxide, or aluminum zinc oxide.

29. The transparent touch panel of claim 18, wherein the interfacial structure includes:
a conductive layer positioned on the bottom surface; and
an insulating polymer layer positioned on the conductive layer.

30. The transparent touch panel of claim 29, wherein the conductive layer includes indium tin oxide, indium zinc oxide, or aluminum zinc oxide.

31. The transparent touch panel of claim 29, wherein the insulating polymer layer includes epoxy resin, polyimide, polyvinyl chloride, or methyl methacrylate.

32. The transparent touch panel of claim 18, wherein the transparent substrate includes glass, polycarbonate, or methyl methacrylate.

33. The transparent touch panel of claim 18, wherein the display device is electro luminescent display device, organic light-emitting display device, or liquid crystal display device.

34. The transparent touch panel of claim 18, further comprising a protective polymer layer covering the capacitive touch device.
